(19) United States
(12) Patent Application Publication
(10) Pub. No.: US 2005/0195727 A1
(43) Pub. Date: Sep. 8, 2005

(54) Optical detection of a light scattering target

(75) Inventors: Shawn A. Ruden, Longmont, CO (US); Thomas Chuang, Longmont, CO (US)

Correspondence Address: Seagate Technology LLC;Intellectual Property - SHK2LG, 1280 Disc Drive, Shakopee, MN, 55379-1863, US

(73) Assignee: Seagate Technology LLC, Scotts Valley, CA (US)

(21) Appl. No.: 10/793,014

(22) Filed: Mar. 3, 2004

(51) Int. Cl. G11B 7/00

(52) U.S. Cl. 369/124.01

(57) ABSTRACT

An apparatus for detecting a light scattering target includes a light source which illuminates a first area of an article with substantially collinear light and a second area surrounding the first area with substantially non-collinear light. An electronic vision system detects a position of a light scattering target within the second area to determine a compliance of said position with a desired position. The substantially collinear light is preferably directed upon the article in a direction substantially perpendicular to a plane along which the article is disposed. A shroud member is preferably disposed between the light source and the article, the shroud member having an aperture through which the light from the light source passes to reach the article, and through which at least a portion of the light is reflected back to the vision system. Preferably, the target is a laser textured index mark on a data storage disc.

### FIELD OF THE INVENTION

The claimed invention relates generally to the field of imaging systems and more particularly, but not by way of limitation, to detecting a light scattering target on an article.

### BACKGROUND

Electronic vision systems are commonly used in automated manufacturing environments. Such systems often employ a camera or similar device (a charge coupled device, CCD, etc.) to optically detect an orientation of an article. This can be used to determine that the article is in a desired, specified orientation, as well as to provide positional feedback for actuated members such as robotic arms that are used to manipulate the article.

Automated manufacturing operations are increasingly used to fabricate a large array of consumer and industrial products, including data storage devices. With the continued demand for improved approaches to implementing automated manufacturing techniques, there remains a continual need for improvements in the art, and it is to such improvements that the claimed invention is generally directed.

### SUMMARY OF THE INVENTION

As embodied herein and as claimed below, the present invention is generally directed to an apparatus for detecting a light scattering target.

In accordance with preferred embodiments, the apparatus comprises a light source which illuminates a first area of an article with substantially collinear light and a second area of the article surrounding the first area with substantially non-collinear light. An electronic vision system detects a position of a light scattering target within the second area to determine a compliance of said position with a desired position.

Preferably, the substantially collinear light is directed upon the article in a direction substantially perpendicular to a plane along which the article is disposed. A shroud member is preferably disposed between the light source and the article. The shroud member has an aperture through which the light from the light source passes to reach the article, and through which at least a portion of the light is reflected back to the vision system.

The vision system preferably comprises a camera which generates a video signal in relation to light from the light source reflected back from the article, and an image processing circuit which generates an image from said video signal and which detects the target from said image.

Preferably, the article comprises a disc stack assembly of a data storage device. The target preferably comprises a laser textured pattern on a disc of the disc stack assembly used as an index mark to provide an angular reference point.

These and various other features and advantages which characterize the claimed invention will become apparent upon reading the following detailed description and upon reviewing the associated drawings.

### BRIEF DESCRIPTION OF THE DRAWINGS

FIG. 1 is an exploded, perspective view of a data storage device constructed in accordance with preferred embodiments of the present invention.

FIG. 2 is a process flow diagram to generally illustrate steps carried out during the formation of a disc stack assembly of the device of FIG. 1.

FIG. 3 is a side elevational representation of an optical detection system used during the flow of FIG. 2.

FIG. 4 generally illustrates different reflectivity characteristics of the top disc of the disc stack assembly.

FIG. 5 depicts an image obtained by the system of FIG. 3.

### DETAILED DESCRIPTION

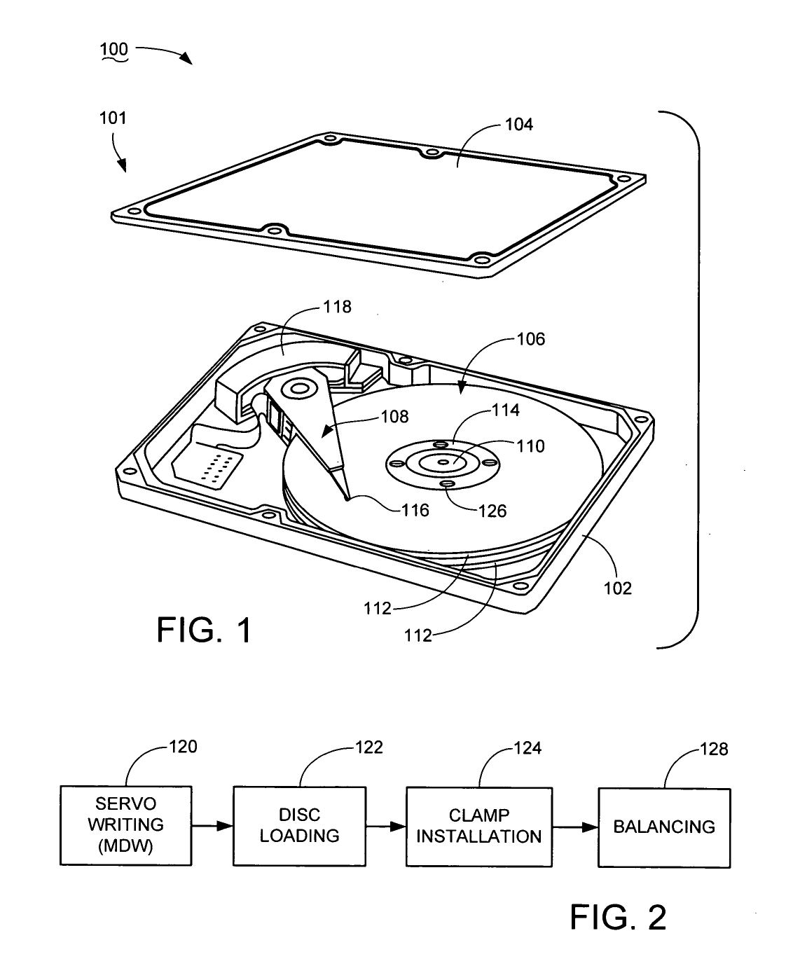

While the claimed invention has utility in any number of different applications, FIG. 1 has been provided to illustrate a particularly suitable environment in which the claimed invention can be advantageously practiced.

FIG. 1 shows an exploded, perspective top plan representation of a data storage device 100 of the type used to magnetically store and retrieve computerized user data. The device 100 includes a sealable housing 101 formed from a base deck 102 and a top cover 104.

The housing 101 provides a controlled interior environment for various constituent components of the device 100, including a disc stack assembly 106 and a head stack assembly 108. The disc stack assembly 106 comprises a spindle motor 110 which rotates a number of data recording discs 112 (in this case, two) at a constant high speed during operation. The discs 112 are secured to a hub of the spindle motor 110 by a disc clamp 114.

The head stack assembly 108 supports a corresponding array of data transducing heads 116 adjacent the disc surfaces. The head stack assembly 108 controllably moves the heads 116 across the radii of the discs through application of current to a voice coil motor, VCM 118. The VCM 118 aligns the heads 116 with tracks (not shown) defined on the disc surfaces to write data to and read data from the discs.

It is contemplated that the device 100 is formed using an automated manufacturing environment. FIG. 2 provides a simplified process flow to illustrate relevant steps associated with the fabrication of the disc stack assembly 106. Initially, servo data used to define the tracks are preferably prewritten to the discs 112 using a multi-disc write (MDW) process at 120.

As described in greater detail below, the discs 112 are each provided with index marks to provide an index position, i.e., a zero angular degrees (0°) reference point. This allows the servo data written during the MDW process step 120 to be arranged with respect to the index position. This also allows the discs 112 to be properly arranged about the spindle motor hub for balancing and track alignment purposes.

At step 122, the discs 112 and an intervening disc spacer (not shown) are loaded onto the hub of the spindle motor 110. The disc clamp 114 is next installed at step 124 to secure the discs 112 and the disc spacer to the spindle motor hub. Preferably, the disc clamp 114 is secured using a number of fasteners 126 (FIG. 1), although other attachment methodologies can be used as well. The assembled disc stack assembly 106 is then provided to a balancing station at step 128 wherein imbalance (if any) is measured and appropriate balance correction weight(s) are applied.

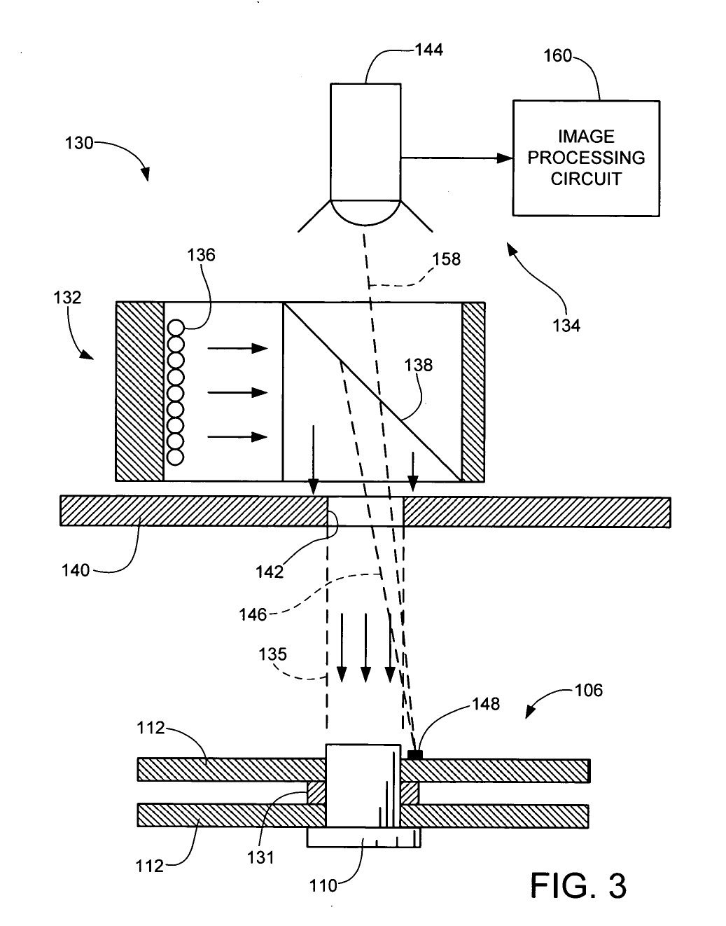

FIG. 3 illustrates an optical detection system 130 preferably used at least during the clamp installation step 124 of FIG. 2 to illuminate the disc stack assembly 106 (herein also referred to as the “article”). For reference, FIG. 3 shows the article 106 to include the aforementioned spindle motor 110, discs 112 and intervening spacer member (numerically denoted at 131).

The optical detection system 130 in FIG. 3 generally includes a light source 132 and an electronic vision system 134. The light source 132 is configured to illuminate a first area of the article 106 with collinear light; that is, with a directed beam of substantially parallel light rays (generally represented in broken line fashion at 135). A suitable commercial embodiment for the light source 132 is the Axial Diffuse Illuminator Model DL2449 available from Advanced Illumination, Inc., Rochester, Vt., U.S.A.

The light source 132 preferably employs an array of light emitting diodes (LEDs) 136. Light from the LEDs 136 is reflected by an angled, semi-translucent window 138 to pass downwardly as shown. A shroud member 140 is interposed between the window 138 and the article 106. The shroud member 140 includes a central aperture 142 that is aligned with the article.

In this way, some of the light from the window 138 is blocked by the shroud member 140 and hence is prevented from reaching the article 106. Another portion of the light from the window 138 (e.g., beam 135) passes through the central aperture 142 to impinge in a substantially perpendicular fashion upon the aforementioned first area of the article, which preferably comprises the top of the spindle motor hub. A substantial portion of this collinear light is reflected back upwardly from the top of the spindle motor hub, through the aperture 142, through the window 138 and to a camera 144 of the vision system 134.

While a substantial portion of the light passing downwardly through the aperture 142 will be collinear and maintained within the beam 135, it will be appreciated that some amount of non-collinear light (i.e., light beams that are somewhat nonparallel and scattered in different directions) will also pass through the aperture 142 and impinge upon a second area of the article 106 surrounding the first area. Some of this non-collinear light is represented in broken line fashion at 146.

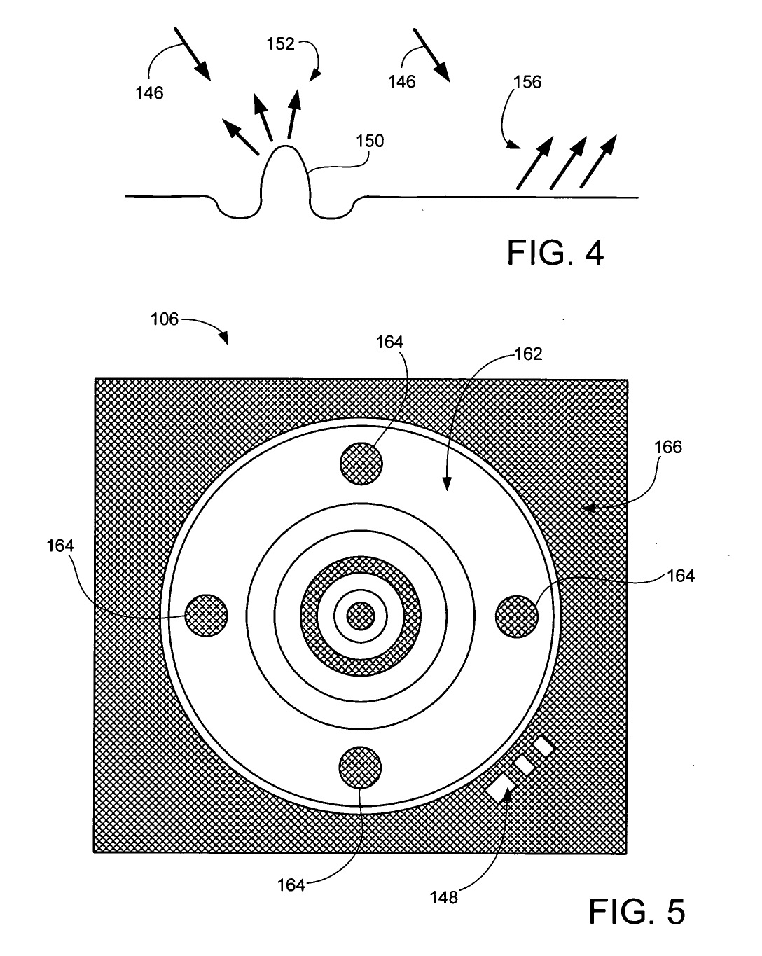

The second area of the article 106 illuminated by the light 146 includes the aforementioned index mark for the top disc 112, which is represented in FIG. 3 at 148. Preferably, the index mark is formed using a laser texturing process to provide a series of localized eruptions, one of which is denoted at 150 in FIG. 4.

The reflective, curvilinear surface of the eruption 150 will generally tend to scatter the incident light 146 in a number of directions (arrows 152). By contrast, the surface of the discs 112 in the areas not affected by the laser texturing process remain highly reflective and will tend to uniformly reflect the incident light 146 away from the aperture 142, as denoted by arrows 156.

Some amount of the incident light 146 directed to the second area will impinge the eruptions 150 of the index mark 148 and be reflected back through the aperture 142 and reach the camera 144, as depicted by return path 158.

Accordingly, during operation the camera 144 will provide a video signal to an image processing circuit 160 which will form an image therefrom, such as illustrated by FIG. 5. As shown in FIG. 5, the top of the spindle motor hub (i.e., the first area which is denoted at 162) has a relatively high reflectivity and will thus have a relatively high brightness level in the image. Apertures 164 in the spindle motor hub used to accommodate the hardware fasteners 126 (FIG. 1) will not reflect light at this same rate, and will thus appear as dark circles as shown. This allows the angular orientation of the apertures 164 to be readily detected by the image processing circuit 160, enabling proper alignment of the clamp 114 during installation.

The second area illuminated by the non-collinear light is denoted in FIG. 5 at 166. The second area will be largely dark in the image due to the reflection of the non-collinear light off of the top disc 112 and away from the aperture 142. However, the index mark 148 will reflect sufficient light so as to be readily visible, as indicated in the image. This allows the image processing circuit 160 to detect the angular and radial position of the index mark and hence determine whether the top disc 112 is properly oriented prior to installation of the clamp 114. It will be noted that while the index mark 148 is illustrated in FIG. 5 as a plurality of different sized marks, any suitable pattern can be used as desired.

An advantage of the system 130 is that the light source 132 can readily be used to detect the index mark 148 without adversely affecting other optical detection operations. Thus, while under ambient conditions the marks are nearly invisible to the naked eye and are difficult to detect using conventionally lighted vision systems, the use of non-collinear light in accordance with the preferred embodiments discussed herein allows ready detection of the marks.

In view of the foregoing, it will now be understood that the present invention, as embodied herein and as claimed below, is generally directed to an apparatus for detecting a light scattering target.

In accordance with preferred embodiments, the apparatus (such as 130) comprises a light source (such as 132) which illuminates a first area of an article (such as 162) with substantially collinear light (such as 135) and a second area (such as 166) of the article surrounding the first area with substantially non-collinear light (such as 146). An electronic vision system (such as 134) detects a position of a light scattering target (such as 148) within the second area to determine a compliance of said position with a desired position.

Preferably, the substantially collinear light is directed upon the article in a direction substantially perpendicular to a plane along which the article is disposed. A shroud member (such as 140) is preferably disposed between the light source and the article, the shroud member having an aperture (such as 142) through which said substantially collinear light and through which said substantially non-collinear light pass to reach the article, and through which at least a portion of this light is reflected back through the aperture to the vision system.

The vision system preferably comprises a camera (such as 144) which generates a video signal in relation to light from the light source reflected back from the article, and an image processing circuit (such as 160) which generates an image from said video signal and which detects the target from said image.

Preferably, the article comprises a disc stack assembly (such as 106) of a data storage device (such as 100) and the target comprises a laser textured pattern (such as 150) on a disc (such as 112) of the disc stack assembly used as an index mark to provide an angular reference point.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the housing without departing from the spirit and scope of the present invention.

In addition, although the embodiments described herein are directed to the sealing of a data storage device housing, it will be appreciated by those skilled in the art that the claimed subject matter is not so limited, but rather extends to any number of different housing applications.

1. An apparatus comprising:
a light source which illuminates a first area of an article with substantially collinear light and a second area of the article surrounding the first area with substantially non-collinear light; and
an electronic vision system which detects a position of a light scattering target within the second area to determine a compliance of said position with a desired position.

2. The apparatus of claim 1, wherein the substantially collinear light is directed upon the article in a direction substantially perpendicular to a plane along which the article is disposed.

3. The apparatus of claim 1, further comprising a shroud member interposed between the light source and the article, the shroud member having an aperture through which said substantially collinear light and through which said substantially non-collinear light pass to reach the article.

4. The apparatus of claim 3, wherein at least respective portions of said substantially collinear light and said substantially non-collinear light are reflected back through the aperture to the vision system.

5. The apparatus of claim 1, wherein the vision system comprises a camera which generates a video signal in relation to light from the light source reflected back from the article.

6. The apparatus of claim 5, wherein the vision system further comprises an image processing circuit which generates an image from said video signal and which detects the target from said image.

7. The apparatus of claim 1, wherein the article comprises a disc stack assembly of a data storage device and wherein the target comprises a laser textured pattern on a disc of the disc stack assembly.

8. The apparatus of claim 7, wherein the laser textured pattern is characterized as an index mark used to identify an angular reference point for the disc.
